(19) United States
(12) Patent Application Publication
(10) Pub. No.: US 2022/0287453 A1
(43) Pub. Date: Sep. 15, 2022

(54) SHEET MUSIC DISPLAY DEVICE

(71) Applicant: Bennet Golemon, Loveland, CO (US)

(72) Inventor: Bennet Golemon, Loveland, CO (US)

(21) Appl. No.: 17/197,882

(22) Filed: Mar. 10, 2021

(51) Int. Cl. A47B 19/00

(52) U.S. Cl. CPC A47B 19/002; A47B 2019/008

(57) ABSTRACT

A sheet music display device, including a display unit constructed to be transparent, a stand assembly, including a body disposed on at least a portion of the display unit, and an illumination unit longitudinally disposed on at least a portion of the body toward the display unit to illuminate the display unit, such that the display unit renders a sheet of music thereon, a pole perpendicularly disposed at a first end away from the stand assembly with respect to a direction, and a base disposed on at least a portion of a second end of the pole to support the pole thereon.

### BACKGROUND

### 1. Field

The present general inventive concept relates generally to music, and particularly, to a sheet music display device.

### 2. Description of the Related Art

Traditional sheet music stands are heavily utilized by most artists during performances to keep track of musical notes and melodies. However, the current sheet music stand models are incredibly outdated and create a barrier between an artist and an audience by obstructing a view of the artist. Obstructing the view of the artist hinders engagement and is frustrating for both the audience and the artist.

Furthermore, the current sheet music stands can be unstable and require the artist to frequently adjust the sheet music when improperly positioned, which can interrupt the music being played. Also, most sheet music is used and poses health risks due to repeated use.

Therefore, there is a need for other a sheet music display device that allows the audience to observe the artist and maintains the sheet music in an upright position.

### SUMMARY

The present general inventive concept provides a sheet music display device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a sheet music display device, including a display unit constructed to be transparent, a stand assembly, including a body disposed on at least a portion of the display unit, and an illumination unit longitudinally disposed on at least a portion of the body toward the display unit to illuminate the display unit, such that the display unit renders a sheet of music thereon, a pole perpendicularly disposed at a first end away from the stand assembly with respect to a direction, and a base disposed on at least a portion of a second end of the pole to support the pole thereon.

The illumination unit may project the sheet of music as at least one beam of light on the display unit.

The illumination unit may project the sheet of music as a hologram floating above the display unit.

The illumination unit may highlight at least one note based on a portion of music being played on the sheet of music.

The illumination unit may enlarge at least one note based on a portion of music being played on the sheet of music.

The stand assembly may further include a plurality of scroll buttons disposed on at least a portion of the body to adjust at least one page of the sheet of music on the display unit in response to depressing at least one of the plurality of scroll buttons, a communication unit disposed within at least a portion of the body to receive a signal from an external device, a speaker disposed on at least a portion of the body to emit at least one sound of at least one note therefrom based on the sheet of music, and a connection port disposed on at least a portion of the body to automatically retrieve and display on the display unit at least one of a song, a music score, and another sheet of music in response to connecting to the external device.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of a sheet music display device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Sheet Music Display Device 100

Display Unit 110

Input Unit 111

Stand Assembly 120

Body 121

Illumination Unit 122

Processing Unit 123

Scroll Buttons 124

Communication Unit 125

Speaker 126

Connection Port 127

Charging Port 128

Power Button 129

Pole 130

Base 140

Adjustment Apertures 141

Stylus 150

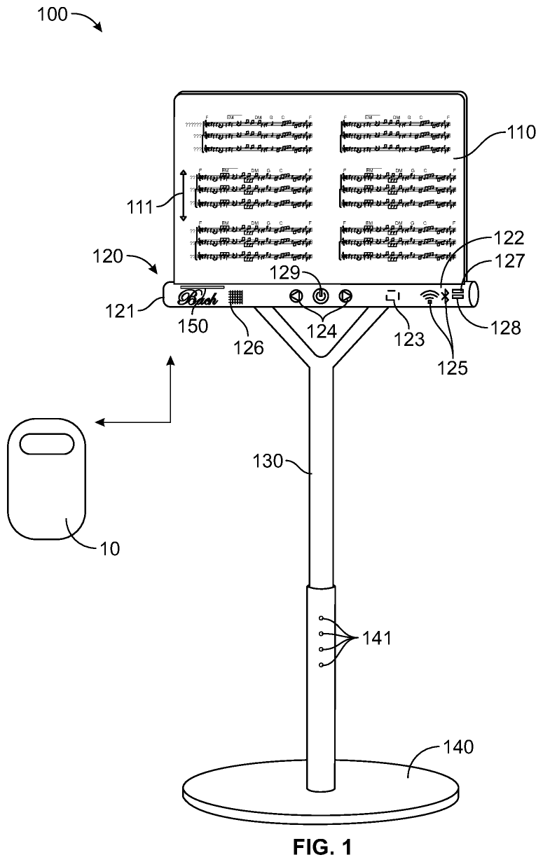

FIG. 1 illustrates a front perspective view of a sheet music display device 100, according to an exemplary embodiment of the present general inventive concept.

The sheet music display device 100 may be constructed from at least one of metal, plastic, wood, glass, ceramic, and rubber, etc., but is not limited thereto.

The sheet music display device 100 may include a display unit 110, a stand assembly 120, a pole 130, a base 140, and a stylus 150, but is not limited thereto.

The display unit 110 may be constructed as a plasma screen, an LCD screen, a light emitting diode (LED) screen, an organic LED (OLED) screen, a computer monitor, a hologram output unit, a sound outputting unit, an LED light, or any other type of device that visually or aurally displays data.

The display unit 110 may include an input unit 111, but is not limited thereto.

The display unit 110 may display a sheet of music thereon. Also, the display unit 110 may be transparent, such that a person, an object, light, and/or a location may be viewed therethrough.

The input unit 111 may include a keyboard, a touchpad, a mouse, a trackball, a stylus, a voice recognition unit, a visual data reader, a camera, a wireless device reader, a fingerprint reader, an iris scanner, a facial recognition unit, and a holographic input unit.

Also, the display unit 110 may be combined with the input unit 111 to be a touchscreen. As such, the input unit 111 may be part of the display unit 110 as a touchscreen input and/or a switch, a button, a lever, and/or a knob on the display unit 110 as a physical input unit.

The input unit 111 may adjust a brightness level of the display unit 110 in response to depressing the input unit 111. More specifically, the display unit 110 may increase the brightness level of the display unit 110 in response to depressing a first button of the input unit 111, and decrease the brightness level of the display unit 110 in response to depressing a second button of the input unit 111.

The stand assembly 120 may include a body 121, an illumination unit 122, a processing unit 123, a plurality of scroll buttons 124, a communication unit 125, a speaker 126, a connection port 127, a charging port 128, and a power button 129, but is not limited thereto.

Referring to FIG. 1, the body 121 is illustrated to have a cylindrical shape. However, the body 121 may be a rectangular prism, circular, conical, pentagonal, hexagonal, heptagonal, octagonal, or any other shape known to one of ordinary skill in the art.

The body 121 may be disposed on at least a portion of a side of the display unit 110. Moreover, a length of the body 121 may be greater than a length of the display unit 110.

The illumination unit 122 may include a light (e.g., an incandescent bulb, a light-emitting diode (LED), a halogen lamp, a xenon lamp) and a projector, but is not limited thereto.

The illumination unit 122 may be longitudinally disposed on at least a portion of the body 121 toward the display unit 110 and extending a length equivalent to the length of the display unit 110. The illumination unit 122 may illuminate at least a portion of the display unit 110. In other words, the display unit 110 may display the sheet of music thereon in response to receiving light from the illumination unit 122.

Alternatively, the illumination unit 122 may project the sheet of music as at least one beam of light on the display unit 110. Furthermore, the display unit 110 may be a planar surface, such that the illumination unit 122 may project a holographic image of the sheet of music. As such, the sheet of music may appear to float above the display unit 110 as a hologram. Also, during use, the illumination unit 122 may highlight and/or enlarge a note and/or a plurality of notes based on a portion of music being played on the sheet of music. Subsequent notes may be highlighted and/or enlarged as the music is played.

The processing unit 123 (or central processing unit, CPU) may include electronic circuitry to carry out instructions of a computer program by performing basic arithmetic, logical, control and input/output (I/O) operations specified by the instructions. The processing unit 123 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 123 may also include a microprocessor, a microcontroller, and a storage unit (e.g., a hard drive, a solid state drive (SSD), a cloud storage drive).

The processing unit 123 may be disposed within at least a portion of the body 121. The processing unit 123 may execute a program and/or a software application stored on the storage unit. Alternatively, the storage unit within the processing unit 123 may download the program and/or the software application from the Internet. For ease of description, the program and/or the software application may be referred to as an app. The processing unit 123 executing the app may render the sheet of music to be displayed on the display unit 110 using the illumination unit 122. Moreover, the illumination unit 122 may illuminate the display unit 110 based on the app executed by the processing unit 123.

Furthermore, the illumination unit 122 may illuminate the display unit 110, such as the note and/or the plurality of notes according to the app. Also, the display unit 110 may automatically change to a next page on the sheet of music. In other words, once a final note on the sheet of music has been highlighted and/or enlarged, the display unit 110 may automatically turn to the next page of the sheet of music.

The display unit 110 may change to the next page on the sheet of music and/or a previous page of the sheet of music in response to the processing unit 123 via the app detecting a swipe motion on the display 110. For example, swiping in a left motion may change to the next page on the sheet of music and swiping in a right motion may change to the previous page on the sheet of music.

The plurality of scroll buttons 124 may be disposed on at least a portion of the body 121. The display unit 110 may adjust at least one page of the sheet of music in response to depressing the plurality of scroll buttons 124. More specifically, the display unit 110 may change to the previous page of the sheet of music in response to depressing a first of the plurality of scroll buttons 124, and change to the next page of the sheet of music in response to depressing a second of the plurality of scroll buttons 124.

The communication unit 125 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The communication unit 125 may be disposed within at least a portion of the body 121. The communication unit 125 may facilitate connection to an external device 10 (e.g., a mobile device, a cell phone, a tablet computer, a laptop computer, a desktop computer, a personal digital assistant (PDA), a watch). Additionally, the communication unit 125 may connect to and/or receive a signal from the external device 10 to send to the processing unit 123 to be display on the display unit 110. For example, the communication unit 125 may receive a song, a music score, and/or another sheet of music to be received by the processing unit 123 executing the app, such that the app may load and/or download the song, the music score, and/or the another sheet of music therein. As such, the communication unit 125 may facilitate a wireless connection to the external device 10.

The speaker 126 may be disposed on at least a portion of the body 121. The speaker 126 may emit at least one sound therefrom based on the sheet of music. For example, the speaker 126 may emit the note and/or the plurality of notes highlighted from the sheet of music on the display unit 110 during play.

The connection port 127 may include a micro universal serial bus (USB) connector, a USB connector, a USB-C connector, and a Lightning connector, but is not limited thereto.

The connection port 127 may be disposed on at least a portion of the body 121. The connection port 127 may connect to the external device 10 using an external cord. In other words, the connection port 127 may facilitate connecting to the external device 10 similar to the communication unit 125 as described above. Moreover, the processing unit 123 executing the app may automatically retrieve (i.e. download) the song, the music score, and/or the another sheet of music in response to the connection port 127 connecting to the external device 10. Also, the display unit 110 may automatically display the song, the music score, and/or the another sheet of music thereon in response to the connection port 127 connecting to the external device 10.

The charging port 128 may include a micro universal serial bus (USB) connector, a USB connector, a USB-C connector, and a Lightning connector, but is not limited thereto.

Furthermore, the charging port 128 may include a power source, such as a battery and a solar cell, but is not limited thereto.

The charging port 128 may be disposed on at least a portion of the body 121 and adjacent to the connection port 127. However, the charging port 128 may prevent connecting to the external device 10. In other words, the charging port 128 may prevent the processing unit 123 executing the app from automatically retrieving the song, the music score, and/or the another sheet of music while connecting to the external device 10. Also, the charging port 128 may connect to an external power source (e.g., a power outlet) to charge and/or receive power therein.

As such, the charging port 128 may send power to the display unit 110 and/or the stand assembly 120.

The power button 129 may be disposed on at least a portion of the body 121 between the first of the plurality of scroll buttons 124 and/or the second of the plurality of scroll buttons 124. The display unit 110 and/or the stand assembly 120 may turn on in response to depressing the power button 129 a first time. Conversely, the display unit 110 and/or the stand assembly 120 may turn off in response to depressing the power button a second time.

The pole 130 may be perpendicularly disposed at a first end away from the body 121 with respect to a direction. Moreover, the pole 130 may support the stand assembly 120 thereon.

The base 140 may include a plurality of adjustment apertures 141, but is not limited thereto.

The base 140 may be disposed on at least a portion of a second end of the pole 130. The base 140 may connect to a surface, such as a ground surface to support the display unit 110, the stand assembly 120, and/or the pole 130 thereon. Additionally, the pole 130 may move telescopically with respect to the base 130 using at least one of the plurality of adjustment apertures 141. More specifically, the second end of the pole 130 may include an adjustment protrusion to protrude through at least one of the plurality of adjustment apertures 141. As such, depressing the adjustment protrusion may allow the pole 130 to move telescopically to another at least one of the plurality of adjustment apertures 141. Therefore, the plurality of adjustment aperture 141 may facilitate height adjustment of the pole 130 with respect to the base 140.

The stylus 150 may be detachably connected to at least a portion of the body 121. The stylus 150 may provide input to the display unit 110. In particular, the stylus 150 may be used to touch the display unit 110 to perform a swipe, a scroll, and/or change a page of the sheet of music.

Therefore, the sheet music display device 100 may allow an artist to play music without having to rely on sheets of paper. Additionally, the sheet music display device 100 may allow an audience to observe the artist during use.

The present general inventive concept may include a sheet music display device 100, including a display unit 110 constructed to be transparent, a stand assembly 120, including a body 121 disposed on at least a portion of the display unit 110, and an illumination unit 122 longitudinally disposed on at least a portion of the body 121 toward the display unit 110 to illuminate the display unit 110, such that the display unit 110 renders a sheet of music thereon, a pole 130 perpendicularly disposed at a first end away from the stand assembly 120 with respect to a direction, and a base 140 disposed on at least a portion of a second end of the pole 130 to support the pole 130 thereon.

The illumination unit 122 may project the sheet of music as at least one beam of light on the display unit 110.

The illumination unit 122 may project the sheet of music as a hologram floating above the display unit 110.

The illumination unit 122 may highlight at least one note based on a portion of music being played on the sheet of music.

The illumination unit 122 may enlarge at least one note based on a portion of music being played on the sheet of music.

The stand assembly 120 may further include a plurality of scroll buttons 124 disposed on at least a portion of the body 121 to adjust at least one page of the sheet of music on the display unit 110 in response to depressing at least one of the plurality of scroll buttons 124, a communication unit 125 disposed within at least a portion of the body 121 to receive a signal from an external device 10, a speaker 126 disposed on at least a portion of the body 121 to emit at least one sound of at least one note therefrom based on the sheet of music, and a connection port 127 disposed on at least a portion of the body 121 to automatically retrieve and display on the display unit 110 at least one of a song, a music score, and another sheet of music in response to connecting to the external device 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A sheet music display device, comprising:
a display unit constructed to be transparent;
a stand assembly, comprising:
a body disposed on at least a portion of the display unit, and
an illumination unit longitudinally disposed on at least a portion of the body toward the display unit to illuminate the display unit, such that the display unit renders a sheet of music thereon;
a pole perpendicularly disposed at a first end away from the stand assembly with respect to a direction; and
a base disposed on at least a portion of a second end of the pole to support the pole thereon.

2. The sheet music display device of claim 1, wherein the illumination unit projects the sheet of music as at least one beam of light on the display unit.

3. The sheet music display device of claim 1, wherein the illumination unit projects the sheet of music as a hologram floating above the display unit.

4. The sheet music display device of claim 1, wherein the illumination unit highlights at least one note based on a portion of music being played on the sheet of music.

5. The sheet music display device of claim 1, wherein the illumination unit enlarges at least one note based on a portion of music being played on the sheet of music.

6. The sheet music display device of claim 1, wherein the stand assembly further comprises:
a plurality of scroll buttons disposed on at least a portion of the body to adjust at least one page of the sheet of music on the display unit in response to depressing at least one of the plurality of scroll buttons;
a communication unit disposed within at least a portion of the body to receive a signal from an external device;
a speaker disposed on at least a portion of the body to emit at least one sound of at least one note therefrom based on the sheet of music; and
a connection port disposed on at least a portion of the body to automatically retrieve and display on the display unit at least one of a song, a music score, and another sheet of music in response to connecting to the external device.
